(19) United States
(12) Patent Application Publication
(10) Pub. No.: US 2008/0227573 A1
(43) Pub. Date: Sep. 18, 2008

(54) Derailleur Shield

(76) Inventors: Eric Strombeck, Tempe, AZ (US); Steve Evans, Tempe, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/032,396

(22) Filed: Feb. 15, 2008

Related U.S. Application Data
(60) Provisional application No. 60/890,393, filed on Feb. 16, 2007.

(51) Int. Cl. B62J 13/00

(52) U.S. Cl. 474/144

(57) ABSTRACT

A device for protecting the derailleur of a bicycle which includes a shield member attached to a clamp member wherein the shield member covers and protects the derailleur of the bicycle and the clamp member is attached to the frame of a bicycle.

### CROSS-REFERENCE TO RELATED APPLICATIONS

This application claims priority to provisional patent application having Ser. No. 60/890,393, filed Feb. 16, 2007, which is herein incorporated in its entirety.

### FIELD OF INVENTION

The present invention generally relates to a shield that protects or guards the rear derailleur of a bicycle and in particular the rear derailleur of a mountain bike. A derailleur is a device used to transfer the chain of a bike from one toothed wheel to another.

### BACKGROUND OF THE INVENTION

Mountain biking and mountain bike racing have become increasingly popular. The terrain for riding and racing mountain bikes is often steep, rough, and fairly rocky. Riders may need to navigate both large and small rocks which can often come into contact with the bicycle itself. As a result, this type of rough terrain may result in damage to the derailleur of a mountain bike and, in particular with mountain bike racing, destroying the derailleur when the mountain bike comes in contact with rocks.

Accordingly, there is a need for a device to protect the derailleur, and in particular the rear derailleur, of a bicycle or mountain bike to ensure that the derailleur of the bicycle is not damaged or destroyed during use. In addition, for those participating in mountain bike racing, such a device may also protect the rear derailleur of a bicycle so that the chain does not become removed from the derailleur during the race thereby resulting in down time to reposition the chain on the derailleur.

### SUMMARY OF THE INVENTION

The derailleur shield of the present invention includes a shield member or cover member, which comprises a flat panel member, and a clamp member for securing the derailleur shield to the frame of a bicycle.

In one exemplary embodiment, the derailleur shield includes a shield member having an outer surface and an inner surface, and a clamp member attached to the inner surface of the shield member. At least one screw member may be used to attach the clamp to the shield member or, alternatively, the shield and clamp member may comprise one continuous piece. The derailleur shield may further include at least one screw member positioned within the clamp to secure the clamp member to a bicycle frame.

The clamp member may comprise a number of shapes including a generally square shape or a generally rectangular shape with an opening therein where the shape of the opening corresponds to the shape of a bicycle frame for attachment. The shield member may also comprise a number of shapes with one exemplary shape being a wing shape.

In another exemplary embodiment, a shield for protecting a derailleur of a bicycle includes a flat panel member having an inner surface, an outer surface, a top and a bottom, and a clamp member attached to the top inner surface of the flat panel member. The protective shield may further include at least one screw member to attach the clamp to the shield member or the flat panel member and the flat panel member and clamp member may comprise one continuous piece. The clamp member may have a top surface, a bottom surface, a front surface, and a back surface wherein the front surface of the clamp member is attached to the top inner surface of the flat panel member. In addition, the protective shield may further include at least one screw member positioned within a top surface of the clamp member to secure the clamp member to a bicycle frame.

### BRIEF DESCRIPTION OF THE DRAWINGS

The present invention is hereafter described in conjunction with the following drawing figures, wherein like numerals denote like elements, and:

FIG. 1 is a perspective view of a rear derailleur of a bicycle;

FIG. 2 is a perspective view of one exemplary embodiment of the derailleur shield of the present invention.

FIG. 3 is a front elevational view of the derailleur shield of the present invention shown attached to the frame of a mountain bike;

FIG. 4 is a rear perspective view of the derailleur shield of the present invention shown attached to the frame of a mountain bike;

FIG. 5 is a top elevational view of the derailleur shield of the present invention shown attached to the frame of a mountain bike;

FIG. 6 is an exploded perspective view of the derailleur shield of the present invention shown prior to attaching the derailleur shield to the frame of a mountain bike;

FIG. 7 is a schematic and perspective view of one exemplary embodiment of one-half of a clamp member of the derailleur shield of the present invention; and

FIG. 8 is a schematic and perspective view of an exemplary embodiment of the other half of the clamp member of the derailleur shield of the present invention shown in FIG. 7.

### DETAILED DESCRIPTION

The following description is of exemplary embodiments of the invention only, and is not intended to limit the scope, applicability or configuration of the invention in any way. Rather, the following description is intended to provide a convenient illustration for implementing various embodiments of the invention. As will become apparent, various changes may be made in the function and arrangement of the elements described in these embodiments without departing from the scope of the invention set forth in the appended claims. For example, in the context of the present invention, the shield member or flat panel member of the device may take the form of a number of shapes. In addition, the clamp member of the device may also take the form of a number of different shapes and functional elements.

In general, the present invention is directed to a shield that protects or guards the derailleur of a bicycle and in particular the rear derailleur of a mountain bike. A derailleur is a device used to transfer the chain of a bike from one toothed wheel to another.

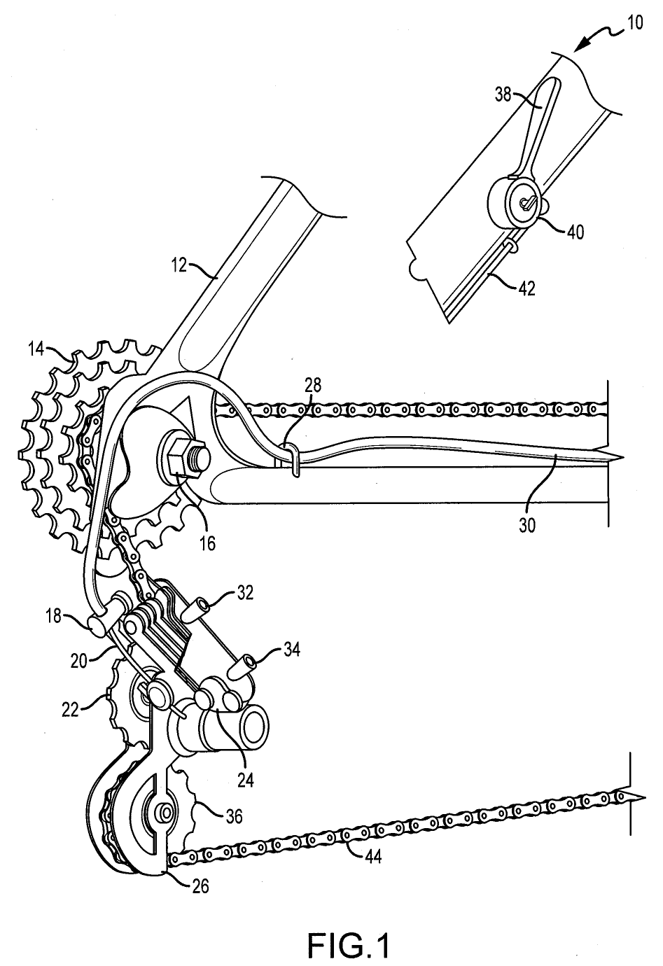

A perspective view of a rear derailleur 10 of a bicycle is shown in FIG. 1. The derailleur 10 may include a number of components attached to the frame 12 of a bicycle. These components may include, but are not limited to, a gear 14, a nut or hub 16, a chain guide 18, a cable 20, a jockey roller 22, a clutch 24, a frame or roller 26, a sheet busting 28, a control cable 30, a tension spring 32, an adjustable stop screw 34, a roller 36, a shifter 38, a locking bolt 40, and a control cable 42. Once connected to the bicycle frame, the derailleur is fairly exposed and the bicycle chain 44 can be easily displaced or damaged if it comes into contact with rocks or other rough terrain.

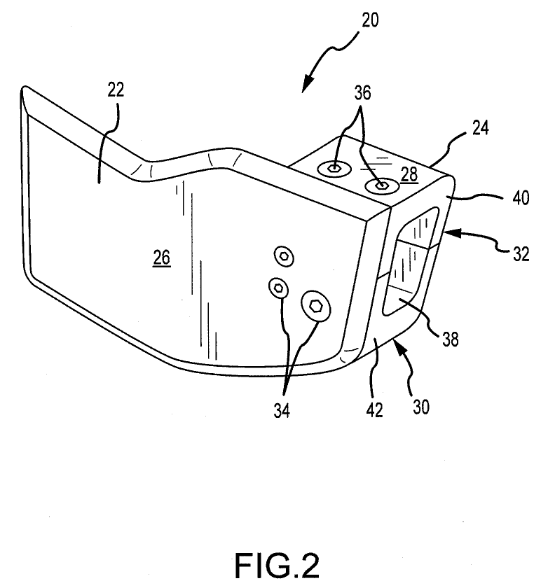

One exemplary embodiment of the derailleur shield of the present invention is shown in FIGS. 2-5. FIG. 2 shows a perspective view of the derailleur shield 20 which includes shield member or flat panel member 22 and clamp member 24. Shield member 22 has an outer surface 26 and an inner surface (not shown). Clamp member 24 includes a top surface 28, a bottom surface 30, a front surface (not shown), and a back surface 32. The front surface (not shown) of clamp member 28 is attached to the inner surface (not shown) of shield member 22.

The derailleur shield 20 may further include at least one screw member 34 for attaching the clamp member 24 to the shield member 22. In addition, clamp member 24 may include one or more screw members 36 positioned within clamp member 24 for securing clamp member 24 to a bicycle frame. Clamp member 24 may comprise a number of shapes including, but not limited to, a generally square shape or a generally rectangular shape. Clamp member 24 may also include an opening 38 which corresponds in shape to a bicycle frame in order to secure clamp member 24 to the bicycle frame. Clamp member 24 may also comprise one or more pieces. For example, clamp member 24 may comprise a top piece 40 and a bottom piece 42.

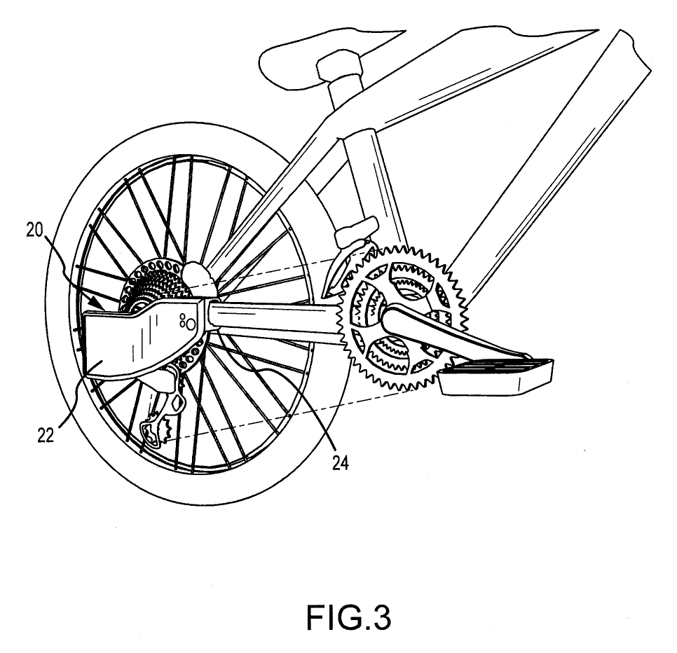

FIG. 3 shows a front elevational view of the derailleur shield 20 of the present invention shown attached to the frame of a mountain bike. Both the shield member 22 and clamp member 24 of derailleur shield 20 may be comprised of a number of materials. However, the components of derailleur shield 20 are preferably comprised of a metal or other strong, durable material that is resistant to damage that may be caused by rough terrain. Other materials include, but are not limited to, plastics, polymers, fiber glass and the like.

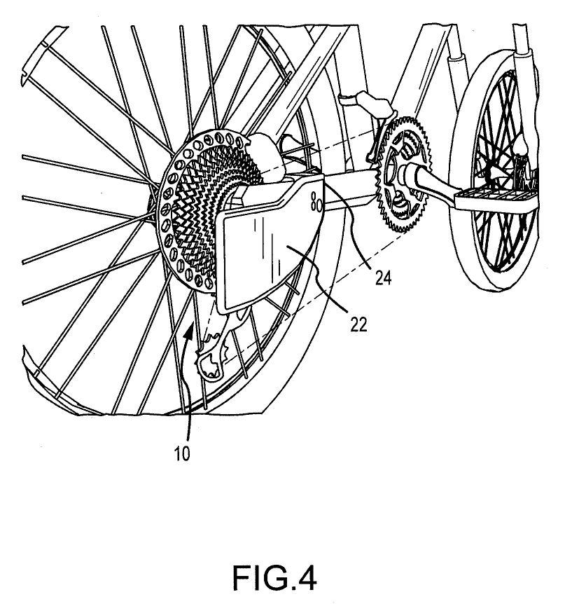

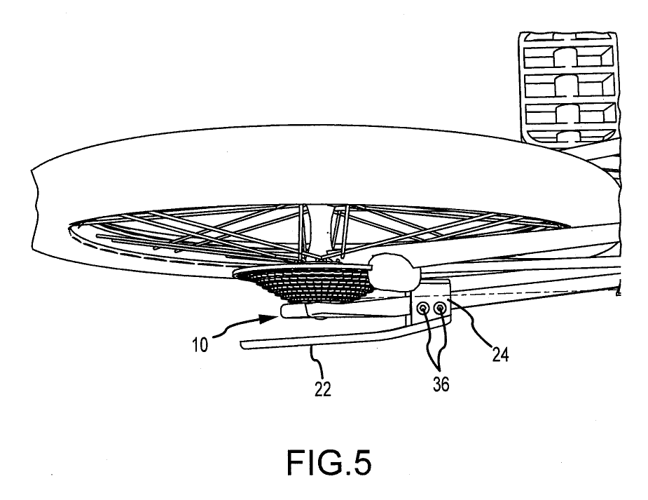

When in use, the clamp member 24 of the derailleur shield 20 is attached to the frame of a bicycle via one or more screw members 36. FIG. 4 shows a rear perspective view of the derailleur shield 20 of the present invention shown attached to the frame of a mountain bike. From this view, one can clearly see that shield member 22 covers and protects derailleur 10. FIG. 5 shows a top elevational view of the derailleur shield 20 of the present invention shown attached to the frame of a mountain bike. FIG. 5 shows screw members 36 in clamp member 24 which is secured to the frame of the bicycle. Again, this view clearly shows that shield member 22 covers and protects derailleur 10.

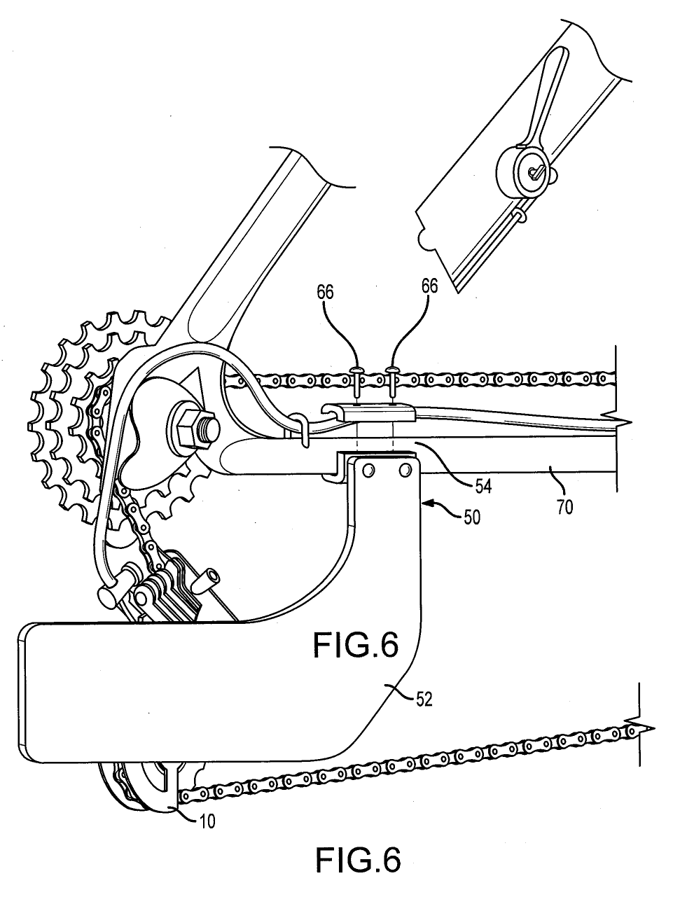

FIG. 6 illustrates another exemplary embodiment of the derailleur shield 50 of the present invention. Derailleur shield 50 includes a shield member or flat panel member 52 and clamp member 54. Clamp member 54 may be attached to shield member 52 such that part of clamp member 54 is positioned above shield member 52 after placement on a bicycle frame. A bottom portion of clamp member 54 may be attached to a top inner surface of shield member 52 as shown in FIG. 6. Screw member 66 may be used to secure clamp member 54 onto bicycle frame 70.

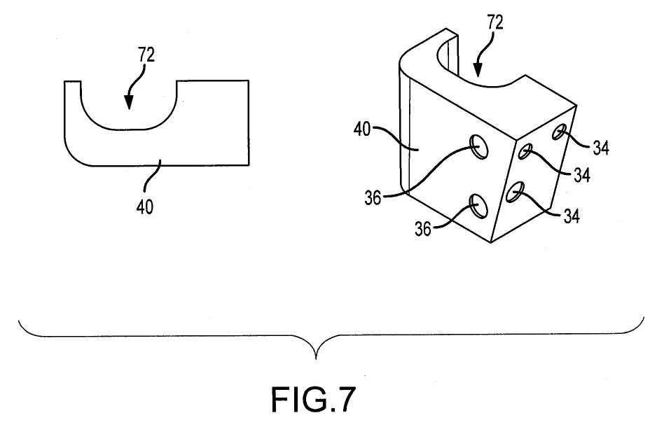

Turning now to FIG. 7, a schematic and perspective view of one exemplary embodiment of one-half of clamp member 24 is shown. Top piece 40 of clamp member 24 may comprise a generally rectangular shape having an indentation 72 therein wherein indentation 72 corresponds to a top portion of a bicycle frame for securing clamp member 24 to the bicycle frame. Top piece 40 may also include a number of openings for inserting screw members or the like. Screw members may be inserted in openings 34 for securing top piece 40 of clamp member 24 to shield member 22 and screw members may be inserted in openings 36 for attaching top piece 40 of clamp member 24 to bottom piece 42 of clamp member 24 and for securing clamp member 24 around part of a bicycle frame.

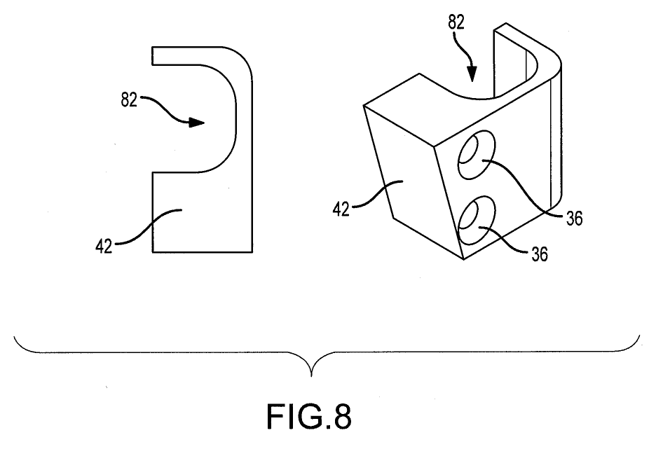

FIG. 8 is a schematic and perspective view of an exemplary embodiment of the bottom piece 42 of clamp member 24. Like top piece 40 of clamp member 24, bottom piece 42 of clamp member 24 may be generally rectangular in shape with an indentation 82 therein which corresponds to a bottom portion of a bicycle frame. Bottom piece 42 of clamp member 24 may also include openings 36 which correspond to openings 36 in top piece 40 so that clamp member 24 can be secured to a bicycle frame with screw members.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A device for protecting the derailleur of a bicycle comprising:
a shield member having an outer surface and an inner surface; and
a clamp member attached to the inner surface of the flat shield member.

2. The device of claim 1 wherein the shield comprises a relatively flat panel member.

3. The device of claim 1 further comprising at least one screw member to attach the clamp to the shield member.

4. The device of claim 1 further comprising at least one screw member positioned within the clamp member to secure the clamp member to a bicycle frame.

5. The device of claim 1 wherein the clamp member comprises at least one of a generally square shape or a generally rectangular shape.

6. The device of claim 5 wherein the clamp member includes an opening therein which has a shape that corresponds to a shape of a bicycle frame.

7. The device of claim 1 wherein the shield member comprises a wing shape.

8. The device of claim 1 wherein the device comprises a single molded piece.

9. A shield for protecting a derailleur of a bicycle comprising:
a flat panel member having an inner surface, an outer surface, a top and a bottom; and
a clamp member attached to the top inner surface of the flat panel member.

10. The device of claim 9 further comprising at least one screw member to attach the clamp to the flat panel member.

11. The device of claim 9 wherein the device comprises a single molded piece.

12. The device of claim 9 wherein the clamp member has a top surface, a bottom surface, a front surface, and a back surface.

13. The device of claim 12 wherein the front surface of the clamp member is attached to the top inner surface of the flat panel member.

14. The device of claim 13 further comprising at least one screw member positioned within a top surface of the clamp member to secure the clamp member to a bicycle frame.

15. The device of claim 9 wherein the clamp member comprises at least one of a generally square shape or a generally rectangular shape.

16. The device of claim 15 wherein the clamp member includes an opening therein which has a shape that corresponds to a shape of a bicycle frame.

17. The device of claim 9 wherein the flat panel member comprises a wing shape.
